(19) United States
(12) Patent Application Publication
(10) Pub. No.: US 2026/0092453 A1
(43) Pub. Date: Apr. 2, 2026

(54) PROTECTED BUILDING PANEL

(71) Applicant: ARMSTRONG WORLD INDUSTRIES, INC., Lancaster, PA (US)

(72) Inventors: Ying CHANG, Lancaster, PA (US); Corey CARVELL, Lititz, PA (US); Timothy ASTON, Columbia, PA (US); Jose NOVA, Notre-Dame-de-L’Ile-Perrot (CA); Bryan F. SHIPP, Dillsburg, PA (US)

(73) Assignee: ARMSTRONG WORLD INDUSTRIES, INC., Lancaster, PA (US)

(21) Appl. No.: 19/338,056

(22) Filed: Sep. 24, 2025

Related U.S. Application Data
(60) Provisional application No. 63/700,728, filed on Sep. 29, 2024.

(51) Int. Cl. E04B 9/04; B32B 3/26; B32B 7/06; B32B 7/12; B32B 15/085

(52) U.S. Cl. CPC E04B 9/0464; B32B 3/266; B32B 7/06; B32B 7/12; B32B 15/085; B32B 2250/02; B32B 2307/7376; B32B 2307/746; B32B 2607/00

(57) ABSTRACT

Described herein is a protected building panel comprising a substrate, a peelable film assembly comprising a film layer having a film thickness, the peelable film formed of a film composition comprising coextruded blend a first polyolefin comprising low-density polyethylene and a second polyolefin that is different from the first polyolefin, an adhesive layer having an adhesive thickness, wherein a ratio of the film thickness to the adhesive thickness ranges from about 3:1 to about 5:1, wherein the protected building panel comprising a plurality of perforations extending continuously through the peelable film assembly and the substrate.

### CROSS-REFERENCE TO RELATED APPLICATION

This Application is a United States Non-Provisional Patent application claiming priority of U.S. Provisional Patent Application No. 63/700,728, filed Sep. 29, 2024, the entirety of which is incorporated by reference herein.

### BACKGROUND

Building materials may typically be damaged during handling and transport to a worksite. While previous attempts at protecting such building materials may exist-such previous attempts raise other issues in terms of difficult to remove protective measures, inferior protection, and/or confusion in recognizing the building material in a protected state. Thus, the need exists for an improved protected building material.

### BRIEF SUMMARY

According to some embodiments, the present invention is a protected building panel having a first major exposed surface opposite a second major exposed surface, the protected building panel comprising: a substrate comprising a first major surface opposite a second major surface; a peelable film assembly comprising: a film layer comprising a first major surface opposite a second major surface, the peelable film having a film thickness as measured by the distance between the first major surface and the second major surface of the peelable film, and the peelable film formed of a film composition comprising coextruded blend a first polyolefin comprising low-density polyethylene and a second polyolefin that is different from the first polyolefin; an adhesive layer comprising a first major surface opposite a second major surface, the adhesive layer having an adhesive thickness as measured by the distance between the first major surface and the second major surface of the adhesive layer; wherein the second major surface of the film layer is adjacent to the first major surface of the substrate by the adhesive layer; wherein a ratio of the film thickness to the adhesive thickness ranges from about 3:1 to about 5:1; wherein the protected building panel comprising a plurality of perforations extending continuously through the peelable film assembly and the substrate.

Other embodiments of the present invention include a protected building panel having a first major exposed surface opposite a second major exposed surface, the protected building panel comprising: a substrate comprising a first major surface opposite a second major surface; a peelable film assembly comprising: a film layer comprising a first major surface opposite a second major surface, the peelable film having a film thickness as measured by the distance between the first major surface and the second major surface of the peelable film, and the peelable film formed of a film composition comprising a coextruded blend a first polyolefin comprising low-density polyethylene and a second polyolefin that is different from the first polyolefin, the film thickness ranging from about 1.0 mils to about 1.5 mils; an adhesive layer comprising a first major surface opposite a second major surface, the adhesive layer having an adhesive thickness as measured by the distance between the first major surface and the second major surface of the adhesive layer, the adhesive layer formed of an adhesive composition comprising poly(butyl acrylate), poly(methyl methacrylate), acrylic copolymer, and a crosslinker, the adhesive thickness ranging from about 0.2 mils to about 0.5 mils; wherein the second major surface of the film layer is adjacent to the first major surface of the substrate by the adhesive layer; and wherein the film layer and the adhesive layer are optically clear.

Other embodiments of the present invention include a protected building panel having a first exposed major surface opposite a second exposed major surface, the protected building panel comprising: a substrate comprising: a central portion comprising an upper surface opposite a lower surface; a perimeter wall portion extending downward from the lower surface of the central portion, the perimeter wall comprising an inner surface opposite an outer surface; a peelable film assembly comprising: a central portion adjacent to the upper surface of the central portion of the substrate and a perimeter portion adjacent to outer surface of the perimeter wall portion of the substrate; the peelable film assembly comprising a film layer having a film thickness, the film layer formed of a film composition comprising coextruded blend a first polyolefin comprising low-density polyethylene and a second polyolefin that is different from the first polyolefin; and an adhesive layer having an adhesive thickness; wherein a ratio of the film thickness to the adhesive thickness ranges from about 3:1 to about 5:1; wherein the protected building panel comprising a plurality of perforations extending continuously through the central portion of the substrate and the central portion of the peelable film assembly and the substrate.

Other embodiments of the present invention include a building panel kit comprising: a plurality of the protected building panels previously discussed, the plurality of the protected building panels comprising at least: a first one of the protected building panels and a second one of the protected building panels arranged in a stacked configuration; wherein the second exposed major surface of the first one of the protected building panels is adjacent to the first exposed major surface of the second one of the protected buildings.

Other embodiments of the present invention include a method of forming a protected building panel comprising: a) providing a continuous sheet of substrate material and providing a continuous sheet of peelable film assembly; b) joining together the continuous sheet of the substrate material and the continuous sheet of the peelable film assembly to form a continuous laminate having an upper surface comprising the peelable film assembly opposite a lower surface comprising the substrate material; c) performing a machining step whereby at least one protected building panel is cut from the continuous laminate, wherein the protected building panel that is cut from the continuous laminate has a panel width and panel length as well as a first major exposed surface opposite a second major exposed surface; and wherein the protected building panel that is cut from the continuous laminate further comprises plurality of perforations that extend continuously from the first major exposed surface to the second major exposed surface of the protected building panel.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is top perspective view of a protected building panel according to the present invention;

FIG. 2A is a cross-sectional view of the protected building panel according to the present invention, the cross-sectional view being along the I-I line set forth in FIG. 1;

FIG. 2B is close-up cross-sectional view of the protected building panel of the present invention in region X of FIG. 2;

FIG. 3 is a plurality of the protected building panels of the present invention;

FIG. 4 is building system comprising at least one of the protected building panels of the present invention; and

FIG. 5 is representation of a manufacturing process of the protected building panels of the present invention;

FIG. 6 is a top perspective view of a protected building panel according to another embodiment of the present invention;

FIG. 7 is a cross-sectional view of the protected building panel according FIG. 6 along line VII-VII.

### DETAILED DESCRIPTION

The following description of the preferred embodiment(s) is merely exemplary in nature and is in no way intended to limit the invention, its application, or uses.

As used throughout, ranges are used as shorthand for describing each and every value that is within the range. Any value within the range can be selected as the terminus of the range. In addition, all references cited herein are hereby incorporated by referenced in their entireties. In the event of a conflict in a definition in the present disclosure and that of a cited reference, the present disclosure controls.

Unless otherwise specified, all percentages and amounts expressed herein and elsewhere in the specification should be understood to refer to percentages by weight. The amounts given are based on the active weight of the material.

The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top,” and “bottom” as well as derivatives thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such.

Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise. Moreover, the features and benefits of the invention are illustrated by reference to the exemplified embodiments. Accordingly, the invention expressly should not be limited to such exemplary embodiments illustrating some possible non-limiting combination of features that may exist alone or in other combinations of features; the scope of the invention being defined by the claims appended hereto.

Unless otherwise specified, all percentages and amounts expressed herein and elsewhere in the specification should be understood to refer to percentages by weight. The amounts given are based on the active weight of the material. According to the present application, the term “about” means +/−5% of the reference value. According to the present application, the term “substantially free” less than about 0.1 wt. % based on the total of the referenced value.

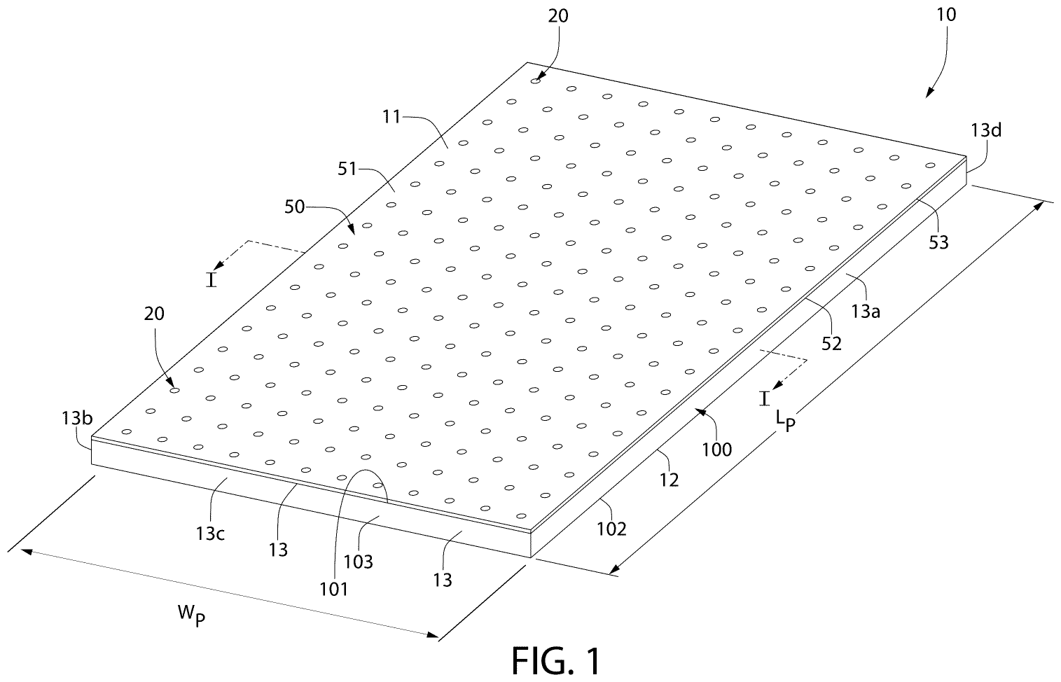

Referring to FIG. 1, a protected building panel 10 of the present invention may comprise a first exposed major surface 11 opposite a second exposed major surface 12. The protected building panel 10 may further comprise a side exposed surface 13 that extends between the first exposed major surface 11 and the second exposed major surface 12, thereby defining a perimeter of the protected building panel 10.

The side exposed surface 13 may comprise a first side surface 13a opposite a second side surface 13b and a third side surface 13c opposite a fourth side surface 13d. The first and second side surfaces 13a, 13b may be substantially parallel. The third and fourth side surfaces 13c, 13d may be substantially parallel. The first and second side surfaces 13a, 13b may be substantially orthogonal to the third and fourth side surface 13c, 13d. The first side surface 13a may intersect the third side surface 13c and the fourth side surface 13d. The second side surface 13b may intersect the third side surface 13c and the fourth side surface 13d.

The protected building panel 10 may have a panel width W_{P} as measured by the distance between the first side surface 13a and the second side surface 13b. The panel width W_{P} may range from about 12 inches to about 48 inches—including all widths and sub-ranges there-between. The protected building panel 10 may have a panel length L_{P} as measured by the distance between the third side surface 13c and the fourth side surface 13d. The panel length L_{P} may range from about 12 inches to about 96 inches—including all widths and sub-ranges there-between.

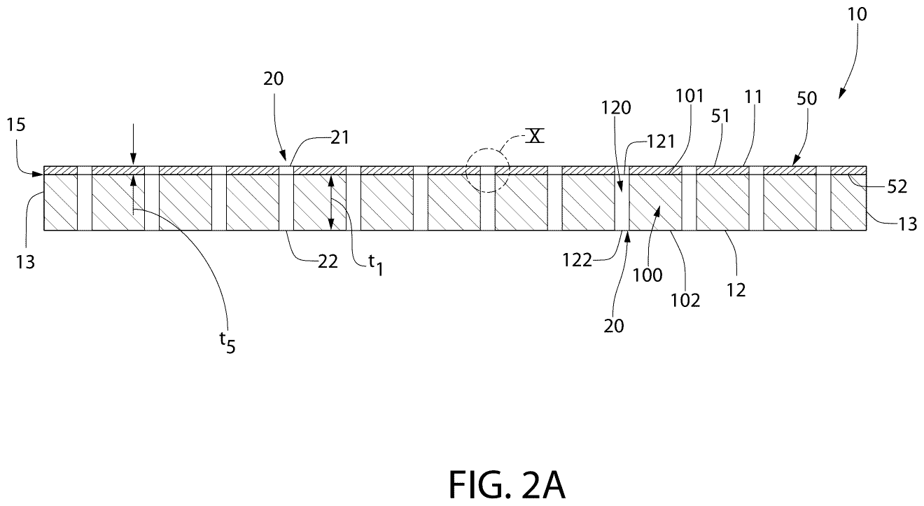

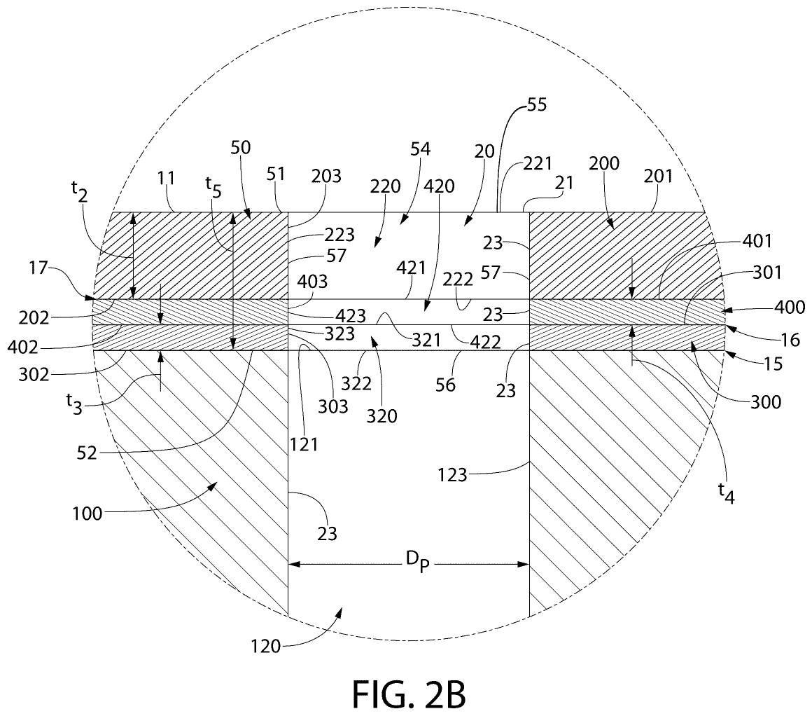

Referring now to FIGS. 1, 2A, and 2B, the protected building panel 10 may comprise a body 100 (also referred to as a “substrate” 100) having an upper surface 101 (also referred to as a “first major surface” 101) opposite a lower surface 102 (also referred to as a “second major surface” 102) and a body side surface 103 (also referred as a “substrate sides surface” 103) that extends between the upper surface 101 and the lower surface 102, thereby defining a perimeter of the body 100. The body 100 may have a body thickness t₁ that extends from the upper surface 101 to the lower surface 102 of the body 100. The body thickness t₁ may be substantially uniform.

The body thickness t₁ may range from about 5.0 mils to about 200 mils—including all values and sub-ranges there-between. In some embodiments, the body thickness t₁ may range from about 10 mils to about 150 mils—including all values and sub-ranges there-between. In some embodiments, the body thickness t₁ may range from about 20 mils to about 100 mils—including all values and sub-ranges there-between.

The protected building panel 10 may comprise a peelable film assembly 50 (also referred to as a “film assembly” 50) having an upper surface 51 (also referred to as a “first major surface” 51) opposite a lower surface 52 (also referred to as a “second major surface” 52) and a film assembly side surface 53 (also referred as a “film assembly side surface” 53) that extends between the upper surface 51 and the lower surface 52, thereby defining a perimeter of the peelable film assembly 50.

The first exposed major surface 11 of the protected building panel 10 may comprise the upper surface 51 of the peelable film assembly 50. Stated otherwise, the upper surface 51 of the peelable film assembly 50 may form the first exposed major surface 11 of the protected building panel 10. The second exposed major surface 12 of the protected building panel 10 may comprise the lower surface 102 of the body 100. Stated otherwise, the lower surface 102 of the body 100 may form the second exposed major surface 12 of the protected building panel 10.

The peelable film assembly 50 may comprise a film layer 200. The peelable film assembly 50 may comprise an adhesive layer 300. The peelable film assembly 50 may comprise the film layer 200 and the adhesive layer 300. In some embodiments, the peelable film assembly 50 may further comprise a print layer 400.

The film layer 200 may comprise an upper surface 201 (also referred to as a “first major surface” 201) opposite a lower surface 202 (also referred to as a “second major surface” 202) and a film layer side surface 203 (also referred as a “film layer side surface” 203) that extends between the upper surface 201 and the lower surface 202 of the film layer 200. The film layer 200 may have a film layer thickness t₂ that extends from the upper surface 201 to the lower surface 202 of the film layer 200. The film layer thickness t₂ may be substantially uniform.

The film layer thickness t₂ may range from about 0.5 mils to about 10.0 mils—including all values and sub-ranges there-between. In some embodiments, the film layer thickness t₂ may range from about 1.0 mils to about 5.0 mils—including all values and sub-ranges there-between. In some embodiments, the film layer thickness t₂ may range from about 1.0 mils to about 1.5 mils—including all values and sub-ranges there-between. In some embodiments, the film layer thickness t₂ may be about 1.3 mils.

The adhesive layer 300 may comprise an upper surface 301 (also referred to as a “first major surface” 301) opposite a lower surface 302 (also referred to as a “second major surface” 302) and an adhesive layer side surface 303 (also referred as a “adhesive layer side surface” 303) that extends between the upper surface 301 and the lower surface 302 of the adhesive layer 300. The adhesive layer 300 may have an adhesive layer thickness t₃ that extends from the upper surface 201 to the lower surface 202 of the film layer 200. The adhesive layer thickness t₃ may be substantially uniform.

The adhesive layer thickness t₃ may range from about 0.1 mils to about 5.0 mils—including all values and sub-ranges there-between. In some embodiments, the adhesive layer thickness t₃ may range from about 0.1 mils to about 1.0 mils—including all values and sub-ranges there-between. In some embodiments, the adhesive layer thickness t₃ may range from about 0.2 mils to about 0.5 mils—including all values and sub-ranges there-between. In some embodiments, the adhesive layer thickness t₃ may be about 0.35 mils.

A ratio of the film layer thickness t₂ to the adhesive layer thickness t₃ may range from about 2.4:1 to about 5.0:1—including all ratios and sub-ranges there-between. In some embodiments, the ratio of the film layer thickness t₂ to the adhesive layer thickness t₃ may range from about 2.7:1 to about 4.7:1—including all ratios and sub-ranges there-between. In some embodiments, the ratio o/f the film layer thickness t₂ to the adhesive layer thickness t₃ may range from about 3.0:1 to about 4.4:1—including all ratios and sub-ranges there-between. In some embodiments, the ratio of the film layer thickness t₂ to the adhesive layer thickness t₃ may range from about 3.3:1 to about 4.1:1—including all ratios and sub-ranges there-between. In some embodiments, the ratio of the film layer thickness t₂ to the adhesive layer thickness t₃ may range from about 3.6:1 to about 3.8:1-including all ratios and sub-ranges there-between. In some embodiments, the ratio of the film layer thickness t₂ to the adhesive layer thickness t₃ may be about 3.7:1. In some embodiments, the ratio of the film layer thickness t₂ to the adhesive layer thickness t₃ may be about 3.71:1.

According to the embodiments where the peelable print assembly 50 comprises the print layer 400, the print layer 400 may comprise an upper surface 401 (also referred to as a “first major surface” 401) opposite a lower surface 402 (also referred to as a “second major surface” 402) and a print layer side surface 403 (also referred as a “print layer side surface” 403) that extends between the upper surface 401 and the lower surface 402 of the print layer 400.

The print layer 400 may have a print adhesive layer thickness ta that extends from the upper surface 401 to the lower surface 402 of the print layer 400. The print layer thickness t₄ may be less than each of the film layer thickness t₂ and the adhesive layer thickness t₃. The print layer 400 may be present in an amount ranging from about 0.5 g/m² to about 10.0 g/m²—including all values and sub-ranges there-between.

The peelable film assembly 50 may comprise the film layer 200 as the topmost layer and the adhesive layer 300 as the bottommost layer. In the embodiments comprising the print layer 400, the print layer 400 may be positioned between the film layer 200 and the adhesive layer 300.

The upper surface 51 of the peelable film assembly 50 may comprise the upper surface 201 of the film layer 200. Stated otherwise, the upper surface 201 of the film layer 200 may form the upper surface 51 of the peelable film assembly 50. The first major exposed surface 11 of the protected building panel 10 may comprise the upper surface 51 of the peelable film assembly 50, which may comprise the upper surface 201 of the film layer 200. Stated otherwise, the upper surface 201 of the film layer 200 may form the upper surface 51 of the peelable film assembly 50, which may form the first major exposed surface 11 of the protected building panel 10.

The film assembly side surface 53 may comprise the side surface 203 of the film layer 200. Stated otherwise, the side surface 203 of the film layer 200 may, at least partially, form the film assembly side surface 53. The film assembly side surface 53 may comprise the side surface 303 of the adhesive layer 300. Stated otherwise, the side surface 303 of the adhesive layer 300 may, at least partially, form the film assembly side surface 53. According to the embodiments comprising the print layer 400, the film assembly side surface 53 may comprise the side surface 403 of the print layer 400. Stated otherwise, the side surface 403 of the print layer 400 may, at least partially, form the film assembly side surface 53.

The lower surface 52 of the peelable film assembly 50 may comprise the lower surface 302 of the adhesive layer 300. Stated otherwise, the lower surface 302 of the adhesive layer 300 may form the lower surface 52 of the peelable film assembly 50.

Referring now to the embodiment shown in FIG. 2B, the lower surface 202 of the film layer 200 may be adjacent to the upper surface 401 of the print layer 400. the lower surface 202 of the film layer 200 may contact the upper surface 401 of the print layer 400. The upper surface 301 of the adhesive layer 300 may be adjacent to the lower surface 402 of the print layer 400. The upper surface 301 of the adhesive layer 300 may contact the lower surface 402 of the print layer 400.

Although not shown, the other embodiments of the present invention may comprise a peelable film assembly 50 comprising the film layer 200 and the adhesive layer 300 without a print layer 400. In such embodiments, the lower surface 202 of the film layer 200 may be adjacent to the upper surface 301 of the adhesive layer 300. In such embodiments, the lower surface 202 of the film layer 200 may be in contact with the upper surface 301 of the adhesive layer 300.

The peelable film assembly 50 may have a film assembly thickness t₅ as measured from the upper surface 51 of the peelable film assembly 50 to the lower surface 52 of the peelable film assembly 50. The film assembly thickness t₅ may range from about 0.5 mils to about 10.0 mils-including all values and sub-ranges there-between. In some embodiments, the film assembly thickness t₅ may range from about 0.6 mils to about 3.0 mils—including all values and sub-ranges there-between. In some embodiments, the film assembly thickness t₅ may range from about 1.5 mils to about 1.8 mils—including all values and sub-ranges there-between. In some embodiments, the film assembly thickness t₅ may be about 1.65 mils.

The film assembly thickness t₅ may be substantially equal to the summation of the film layer thickness t₂, the adhesive layer thickness t₃, and the print layer thickness t₄ (for the embodiments comprising a print layer 400). The film assembly thickness t₅ may be substantially uniform.

The upper surface 101 of the body 100 may exhibit a surface topography that is smooth, satin, semi-gloss, or lightly textured, whereby the surface roughness (Ra) ranging from about 0.5 μm to about 3.5 μm. The upper surface 101 of the body 100 may exhibit a surface energy ranging from about 30 dyne to about 45 dyne—including all surface energies and sub-ranges there-between. In some embodiments, the upper surface 101 of the body 100 may exhibit a surface energy ranging from about 32 dyne to about 34 dyne—including all surface energies and sub-ranges there-between.

The protected building panel 10 may comprise the peelable film assembly 50 positioned adjacent to the body 100. The peelable film assembly 50 may contact the body 100 to form a panel interface 15. In particular, the protected building panel 10 may comprise the peelable film assembly 50 positioned adjacent to the upper surface 101 of the body 100. The peelable film assembly 50 may contact the upper surface 101 of the body 100 to form the panel interface 15. The lower surface 51 of the peelable film assembly 50 may be adjacent to the upper surface 101 of the body 100. The lower surface 51 of the peelable film assembly 50 may contact the upper surface 101 of the body 100 to form the panel interface 15.

The lower surface 302 of the adhesive layer 300 in the peelable film assembly 50 may be adjacent to the body 100. The lower surface 302 of the adhesive layer 300 in the peelable film assembly 50 may contact the body 100 to form the panel interface 15. The lower surface 302 of the adhesive layer 300 in the peelable film assembly 50 may be adjacent to the upper surface 101 of the body 100. The lower surface 302 of the adhesive layer 300 in the peelable film assembly 50 may contact the upper surface 101 of the body 100 to form the panel interface 15.

The adhesive layer 300 may temporarily bond the peelable film assembly 50 to the body 100. The term “temporarily” refers to the peelable film assembly 50 being adhesively bonded to the body 100 such that it may form and maintain continuous contact between the upper surface 101 of the body 100 and the lower surface 51 of the peelable film assembly 50 without premature delamination within the panel interface 15 while also being capable of being peeled from the body 100 (i.e., breaking the panel interface 15) at a later desired time without portions of the adhesive layer 300 and/or film layer 200 remaining on the body 100—including without any portions of the print layer 400 remaining on the body 100 for the embodiments where the peelable film assembly 50 comprises the print layer 400.

In particular, the adhesive layer 300 may temporarily bond the lower surface 52 of the peelable film assembly 50 to the upper surface 101 of the body 100. The lower surface 52 of the peelable film assembly 50 may adhesively bond to the upper surface 101 of the body 100 such that it may form and maintain continuous contact between the upper surface 101 of the body 100 and the lower surface 51 of the peelable film assembly 50 without premature delamination within the panel interface 15 while also being capable of being peeled from the upper surface 101 of the body 100 (i.e., breaking the panel interface 15) at a later desired time without portions of the adhesive layer 300 and/or film layer 200 remaining on the upper surface 101 of the body 100—including without any portions of the print layer 400 remaining on the upper surface 101 of the body 100 for the embodiments where the peelable film assembly 50 comprises the print layer 400.

For the embodiments comprising a print layer 400, a first film assembly interface 16 may exist between the print layer 400 and the adhesive layer 300. The first film assembly interface 16 may exist between the lower surface 402 of the print layer 400 and the upper surface 302 of the adhesive layer 300.

For the embodiments comprising a print layer 400, a second film assembly interface 17 may exist between the film layer 200 and the print layer 400. The second film assembly interface 17 may exist between the lower surface 202 of the film layer 200 and the upper surface 402 of the print layer 400.

For the embodiments not comprising a print layer 400 (not shown), the peelable film assembly may comprise only the first film assembly interface 16, which may exist between the film layer 200 and the adhesive layer 300. Specifically, for the embodiments not comprising a print layer 400 (not shown), the peelable film assembly 50 may comprise only the first film assembly interface 16 located between the lower surface 202 of the film layer 200 and the upper surface 301 of the adhesive layer 300.

According to the present invention, the temporary bond that exists along the panel interface 15 may be broken when the peelable film assembly is removed (e.g., peeled) from the body 100 such that the panel interface 15 is broken without the first film assembly interface 16 or the second film assembly interface 17 being broken. The first film assembly interface 16 and/or second film assembly interface 17 may undergo deformation during such peeling step, but ultimately the interfaces 16, 17 will not rupture.

According to the embodiments where the peelable film assembly 50 does not comprise a print layer, the temporary bond that exists along the panel interface 15 may be broken when the peelable film assembly 50 is removed (e.g., peeled) from the body 100 without the first film assembly interface 16, which exists between the film layer 200 and the adhesive layer 300, being broken. In such embodiments, the first film assembly interface 16 may undergo deformation during such peeling step, but ultimately the assembly interface will not rupture.

The protected building panel 10 may comprise a plurality of panel perforations 20. Each of the plurality of panel perforations 20 extend continuously from the first exposed major surface 11 of the protected building panel 10 to the second exposed major surface 12 of the protected building panel 10. Each of the plurality of panel perforations 20 create an open-pathway for fluid communication from the first exposed major surface 11 to the second exposed major surface 12 of the protected building panel 10. The plurality of perforations may be inset from the perimeter of the protected building panel 10 by a positive, non-zero distance equal to at least the size of each perforation.

The perforations may have a cross-sectional shape that is circular, ovular, polygonal, or irregular. In some embodiments, the perforations has a cross-sectional shape that is circular.

Each of the plurality of panel perforations 20 comprise a first opening 21 opposite a second opening 22, the first opening 21 located at the first exposed major surface 11 of the protected building panel 10 and the second opening 22 located at the second exposed major surface 12 of the protected building panel 10. The height of each of the plurality of panel perforations 20 being substantially equal to the panel thickness to.

Each of the plurality of panel perforations 20 circumscribed by a perforation wall 23 that extends continuously from the first opening 21 to the second opening 22. Each of the plurality of panel perforations 20 having a perforation diameter D_{P} as measured by opposite sides of the perforation wall 23. The perforation diameter D_{P} ranging from about 0.5 mm to about 77 mm-including all diameters and sub-ranges there-between. In some embodiments, the perforation diameter D_{P} may range from about 1.0 mm to about 26 mm—including all diameters and sub-ranges there-between.

The plurality of panel perforations 20 may be present in a perforation density ranging from about 10 perforation/m² to about 250,000 perforation/m²—including all perforation densities and sub-ranges there-between.

The peelable film assembly 50 may comprise a plurality of assembly perforations 54. Each of the plurality of assembly perforations 54 may extend continuously from the upper surface 51 of the peelable film assembly 50 to the lower surface 52 of the peelable film assembly 50. Each of the plurality of assembly perforations 54 may create an open-pathway for fluid communication from the upper surface 51 to the lower surface 52 of the peelable film assembly 50.

Each of the plurality of assembly perforations 54 comprise a first opening 55 opposite a second opening 56, the first opening 55 located at the upper surface 51 of the peelable assembly layer 50 and the second opening 56 located at the lower surface 52 of the peelable film assembly 50. The height of each of the plurality of assembly perforation 54 being substantially equal to the film assembly thickness t₅.

Each of the plurality of assembly perforations 54 are circumscribed by an assembly perforation wall 57 that extends continuously from the first opening 55 to the second opening 56 of the assembly perforation 54. Each of the plurality of assembly perforations 54 having an assembly perforation diameter that is substantially equal to the perforation diameter D_{P}. The assembly perforation wall 57 of each assembly perforation 54 overlapping and flush with the peroration wall 23 of the overall panel perforations 20.

The film layer 200 may comprise a plurality of film perforations 220. Each of the plurality of film perforations 220 extend continuously from the upper surface 211 of the film layer 200 to the lower surface 212 of the film layer 200. Each of the plurality of film perforations 220 create an open-pathway for fluid communication from the upper surface 211 to the lower surface 212 of the film layer 200.

Each of the plurality of film perforations 220 comprise a first opening 221 opposite a second opening 222, the first opening 221 located at the upper surface 211 of the film layer 200 and the second opening 222 located at the lower surface 212 of the film layer 200. The height of each of the plurality of film perforations 220 being substantially equal to the film thickness t₂. The first opening 221 of the film perforations 220 may coincide with the first opening 55 of the assembly perforations 54.

Each of the plurality of film perforations 220 are circumscribed by a film perforation wall 223 that extends continuously from the first opening 221 to the second opening 222 of the film perforation 220. Each of the plurality of film perforations 220 having a film perforation diameter that is substantially equal to the perforation diameter D_{P}. The film perforation wall 223 of each film perforation 220 overlapping and flush with the peroration wall 23 of the overall panel perforations 20.

The adhesive layer 300 may comprise a plurality of adhesive perforations 320. Each of the plurality of adhesive perforations 320 extend continuously from the upper surface 311 of the adhesive layer 300 to the lower surface 312 of the adhesive layer 300. Each of the plurality of adhesive perforations 320 create an open-pathway for fluid communication from the upper surface 311 to the lower surface 312 of the adhesive layer 300.

Each of the plurality of adhesive perforations 320 comprise a first opening 321 opposite a second opening 322, the first opening 321 located at the upper surface 311 of the adhesive layer 300 and the second opening 322 located at the lower surface 312 of the adhesive layer 300. The height of each of the plurality of adhesive perforation 320 being substantially equal to the adhesive thickness t₃. The second opening 322 of the adhesive perforations 320 may coincide with the second opening 56 of the assembly perforations 54.

Each of the plurality of adhesive perforations 320 are circumscribed by an adhesive perforation wall 323 that extends continuously from the first opening 321 to the second opening 322 of the adhesive perforation 320. Each of the plurality of adhesive perforations 320 having an adhesive perforation diameter that is substantially equal to the perforation diameter D_{P}. The adhesive perforation wall 323 of each adhesive perforation 320 overlapping and flush with the peroration wall 23 of the overall panel perforations 20.

According to the embodiments comprising a print layer, the print layer 400 may comprise a plurality of print perforations 420. Each of the plurality of print perforations 420 extend continuously from the upper surface 411 of the print layer 400 to the lower surface 412 of the print layer 400. Each of the plurality of print perforations 420 create an open-pathway for fluid communication from the upper surface 411 to the lower surface 412 of the print layer 400.

Each of the plurality of print perforations 420 comprise a first opening 421 opposite a second opening 422, the first opening 421 located at the upper surface 411 of the print layer 400 and the second opening 422 located at the lower surface 412 of the print layer 400. The height of each of the plurality of print perforation 420 being substantially equal to the print thickness t₄.

Each of the plurality of print perforations 420 are circumscribed by a print perforation wall 423 that extends continuously from the first opening 421 to the second opening 422 of the print perforation 420. Each of the plurality of print perforations 420 having a print perforation diameter that is substantially equal to the perforation diameter D_{P}. The print perforation wall 423 of each print perforation 420 overlapping and flush with the peroration wall 23 of the overall panel perforations 20.

The assembly perforation wall 57 may comprise each of the film assembly wall 223 and the adhesive layer wall 323. For the embodiments comprising a print layer 400, the assembly perforation wall 57 may comprise each of the film assembly wall 223, the print layer wall 423, and the adhesive layer wall 323.

The body 100 may comprise a plurality of body perforations 120. Each of the plurality of body perforations 120 extend continuously from the upper surface 111 of the body 100 to the lower surface 112 of the body 100. Each of the plurality of body perforations 120 create an open-pathway for fluid communication from the upper surface 111 to the lower surface 112 of the body 100.

Each of the plurality of body perforations 120 comprise a first opening 121 opposite a second opening 122, the first opening 121 located at the upper surface 111 of the body 100 and the second opening 122 located at the lower surface 112 of the body 100. The height of each of the plurality of body perforation 120 being substantially equal to the body thickness t₁.

Each of the plurality of body perforations 120 are circumscribed by a body perforation wall 123 that extends continuously from the first opening 121 to the second opening 122 of the body perforation 120. Each of the plurality of body perforations 120 having a body perforation diameter that is substantially equal to the perforation diameter D_{P}. The body perforation wall 123 of each body perforation 120 overlapping and flush with the peroration wall 23 of the overall panel perforations 20.

The panel perforation wall 23 may comprise the film perforation wall 223, the adhesive perforation wall 323, and the body perforation wall 123. The film perforation wall 223, the adhesive perforation wall 323, and the body perforation wall 123 may all be flush with the panel perforation wall 23.

The body 100 may be formed of a body composition. The body composition may comprise a metal, ceramic, polymeric, cellulosic, or composite material. In some embodiments, the body composition is metallic. Non-limiting examples of metallic body compositions include aluminum, steel, tin, copper, nickel. The body composition may further comprise one or more composite materials.

The film layer 200 may be formed of a film composition. The film layer may comprise the film composition. The film layer may be formed by 100 wt. % of the film composition. The film layer may consist of the film composition.

The film layer 200 may be “substantially clear” (also referred to optically clear) or “substantially transparent” may also refer to the coating having at least 80% optical clarity, whereby 100% optical clarity refers to an underlying surface (e.g., the print layer 400) being completely unhindered visually by the film layer 200.

The film composition may comprise a polymer. The polymer may be a polyolefin polymer. The polymer may comprise a blend of two or more polymers. The blend may be a coextruded blend of the two or more polymers. The blend of polymer may comprise a first polymer and a second polymer that is different from the first polymer. The term “different” in the context of first polymer and second polymer may refer to different backbone chemistries, molecular weights, and/or polymer backbone structures.

As a non-limiting example, a first polymer may comprise a polyethylene polyolefin that is an LDPE polyethylene and the second polymer may comprise a polyethylene polyolefin that is a HDPE polyethylene. In this example, both polymers are polyethylene, but are different as LDPE and HDPE have different backbone branching (e.g., HDPE being linear and LDPE being branched), thus the two polyolefin are different.

As another non-limiting example, a first polymer may comprise a polyethylene polyolefin that is an LDPE polyethylene and the second polymer may comprise a polyethylene polyolefin that is also LDPE polyethylene-however, the LDPE of the first polyolefin may have a first molecular weight and the LDPE of the second polyolefin may have a second molecular weight, whereby the first and second molecular weights are not equal-hence, the first and second polyolefin are different.

The film composition may comprise the polymer in an amount ranging from about 60 wt. % to about 95 wt. %-based on the total weight of the film composition—including all wt. % and sub-ranges there-between. In some embodiments, the film composition may comprise the polymer in an amount ranging from about 65 wt. % to about 95 wt. %-based on the total weight of the film composition—including all wt. % and sub-ranges there-between. In some embodiments, the film composition may comprise the polymer in an amount ranging from about 70 wt. % to about 95 wt. %-based on the total weight of the film composition—including all wt. % and sub-ranges there-between. In some embodiments, the film composition may comprise the polymer in an amount ranging from about 75 wt. % to about 95 wt. %-based on the total weight of the film composition—including all wt. % and sub-ranges there-between.

The film composition may comprise one or more processing additives. In a non-limiting embodiment, the processing additive may include a slip additive. Non-limiting examples of slip additives include one or more of saturated fatty acid amides (such as palmitamide, stearamide, arachidamide, behenamide, stearyl stearamide, palmityl pamitamide, and stearyl arachidamide); saturated ethylene-bis-amides (such as stearamido-ethyl-stearamide, stearamido-ethyl-palmitamide, and palmitamido-ethyl-stearamide); unsaturated fatty acid amides (such as olcamide, erucamide, and linoleamide); unsaturated ethylene-bis-amides (such as ethylene-bis-stearamide, ethylene-bis-oleamide, stearyl-crucamide, crucamido-ethyl-erucamide, oleamido-ethyl-oleamide, crucamido-ethyl-oleamide, oleamido-ethyl-lerucamide, stearamido-ethyl-crucamide, crucamido-ethyl-palmitamide, and palmitamido-ethyl-olcamide); glycols; polyether polyols (such as Carbowax); acids of aliphatic hydrocarbons (such as adipic acid and sebacic acid); esters of aromatic or aliphatic hydrocarbons (such as glycerol monostearate and pentacrythritol monooleate); styrene-alpha-methyl styrene; fluoro-containing polymers (such as polytetrafluoroethylene, fluorine oils, and fluorine waxes); silicon compounds (such as silanes and silicone polymers, including silicone oils, modified silicones and cured silicones); sodium alkylsulfates, alkyl phosphoric acid esters; and mixtures thereof.

In some embodiments, the slip additives may include one or more of unsaturated fatty acid amides-such as those having the chemical structure:

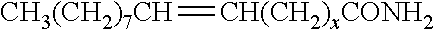

where x is 5 to 15. In some embodiments, the slip additive may be the above compound having x is 11, also referred to as cis-13-docosenoamide, Oleylamide, where x is 8; and/or Oleamide, where x is 7 (also referred to as N-9-octadecenyl-hexadecanamide).

The slip additive may be present in the film composition in an amount ranging from about 0 wt. % to about 5 wt. %-based on the total weight of the film composition—including all wt. % and sub-ranges there-between. In some embodiments, the slip additive may be present in the film composition in a non-zero wt. % up to about 5 wt. %-based on the total weight of the film composition—including all wt. % and sub-ranges there-between.

The film composition may further comprise one or more anti-blocking additives which may be added during the production of the film. A non-limiting example of anti-blocking additive may include diatomaceous earths. The anti-blocking additive may be present in an amount ranging from about 0 wt. % to about 5 wt. %-based on the total weight of the film composition—including all wt. % and sub-ranges there-between. In some embodiments, the anti-blocking additive may be present in the film composition in a non-zero wt. % up to about 5 wt. %-based on the total weight of the film composition—including all wt. % and sub-ranges there-between.

The film composition may comprise one or more other additives and/or colorants. Such additives may include antioxidants, nucleating agents, acid scavengers, stabilizers, anticorrosion agents, plasticizers, blowing agents, cavitating agents, surfactants, adjuvants, block, UV absorbers such as chain-breaking antioxidants, etc., quenchers, antistatic agents, slip agents, processing aids, UV stabilizers, neutralizers, lubricants, waxes, color masterbatches, pigments, dyes and fillers and cure agents such as peroxide. Preferred fillers, cavitating agents and/or nucleating agents include titanium dioxide, calcium carbonate, barium sulfate, silica, silicon dioxide, carbon black, sand, glass beads, mineral aggregates, talc, clay and the like.

The additive and/or colorants may be present in an amount ranging from about 0.0 wt. % up to 15 wt. %-based on the total weight of the film composition—including all wt. % and sub-ranges there-between.

The adhesive layer 300 may be formed of an adhesive composition. The adhesive layer may be a pressure sensitive adhesive. The adhesive composition may be formed of a pressure sensitive adhesive composition. The adhesive layer may not be a thermally activated adhesive-meaning, that the adhesive layer may exhibit bonding strength at room temperature and not need elevated temperatures in order to properly bond adjacent layers together.

The adhesive composition may comprise a blend of a first polymer and a second polymer—the first polymer and the second polymer of the adhesive composition being different. The first polymer of the adhesive composition may be a low-Tg polymer and the second polymer of the adhesive composition may be a high-Tg polymer. The term “low-Tg” may refer to a polymer having a glass transition temperature less than about −40° C. The term “high-Tg” may refer to a polymer having a glass transition temperature greater than about 90° C.—preferably greater than 100° C.

In some embodiments, the first polymer may comprise poly(butyl acrylate). In some embodiments, the first polymer may comprise poly(methyl methacrylate).

The adhesive may comprise the first polymer in an amount ranging from about 40 wt. % to about 90 wt. % based on the total weight of the adhesive composition—including all wt. % and sub-ranges there-between. The adhesive may comprise the second polymer in an amount ranging from about 10 wt. % to about 30 wt. % based on the total weight of the adhesive composition-including all wt. % and sub-ranges there-between.

In some embodiments, the blend comprising the first polymer and second polymer of the adhesive composition may further comprise a third polymer. The third polymer of the adhesive composition may comprise an acrylic copolymer. The third copolymer may be present in an amount ranging from about 10 wt. % to about 30 wt. % based on the total weight of the adhesive composition—including all wt. % and sub-ranges there-between. In some embodiments, the third copolymer may be present in an amount ranging from a non-zero wt. % to about 30 wt. % based on the total weight of the adhesive composition—including all wt. % and sub-ranges there-between. In some embodiments, the third copolymer may be present in an amount ranging from about 5 wt. % to about 30 wt. % based on the total weight of the adhesive composition—including all wt. % and sub-ranges there-between. In some embodiments, the third copolymer may be present in an amount ranging from about 10 wt. % to about 30 wt. % based on the total weight of the adhesive composition—including all wt. % and sub-ranges there-between. The acrylic copolymer of the third polymer may comprise poly(ethyl acrylate-co-methacrylic acid-co-methyl methacrylate).

The adhesive composition may further comprise a crosslinker. The crosslinker may comprise one or more of aluminum acetylacetonate, N-(hydroxymethyl) acrylamide, 1,1′-Carbonyldiimidazole, and combinations thereof. The crosslinker may be present in an amount ranging from about 0.5 wt. % to about 5.0 wt. % based on the total weight of the adhesive composition—including all wt. % and sub-ranges there-between.

The adhesive composition may be substantially free of tackifier. Non-limiting examples of tackifier include, rosin, rosin derivatives, polyterpene resins, coumarone-indene resins, and the like. The adhesive may be substantially clear, whereby 100% optical clarity refers to an underlying surface (e.g., the body 100) being completely unhindered visually by the adhesive layer 300.

The print layer 400 may be formed of a print composition. The print composition may comprise one or more pigments, inks, and combinations thereof. The print composition may comprise one or more carriers and/or binders.

The combination of both the film layer 200 and the adhesive layer 300 being optically clear—the result is the protected building panel 10 allowing for the optical properties of the underlying body 100 to be visually apparent from the first major exposed surface 11 of the protected building panel 10. Such characteristic may allow a user to readily identify what is the type of body 100 (for example, in a setting where various types of different bodies are present) and select the desired body 100 even with the peelable film assembly 50 still bonded to the body 100.

According to the embodiments comprising the print layer 400, the combination of both the film layer 200 and the adhesive layer 300 being optically clear—the result is the protected building panel 10 allowing for the optical properties of the underlying body 100 as well as the print layer 400 to be visually apparent from the first major exposed surface 11 of the protected building panel 10. Such characteristic may allow a user to readily identify what is the type of body 100 as well as discern the markings provided by the print layer 400 (for example, in a setting where various types of different bodies are present with various print layers) and select the desired body 100 even with the peelable film assembly 50 still bonded to the body 100.

The combination of both the film layer 200 and the adhesive layer 300 being optically clear—the result is the protected building panel 10 allowing for the optical properties of the underlying body 100 to be visually apparent from the first major exposed surface 11 of the protected building panel 10. Such characteristic may allow a user to readily identify what is the type of body 100 (for example, in a setting where various types of different bodies are present) and select the desired body 100 even with the peelable film assembly 50 still bonded to the body 100.

In some embodiments, the protected building panel 10 may comprise a release coating composition positioned within the panel interface 15. The release coating composition may help ensures the peelable film assembly 50 can be removed from the body 100 without leaving any residue or losing adhesion property. Non-limiting examples of release coating compositions may comprise polydimethylsiloxane, N,N′-methylenebisacrylamide, and combinations thereof, as well as catalyst such platinum type catalyst.

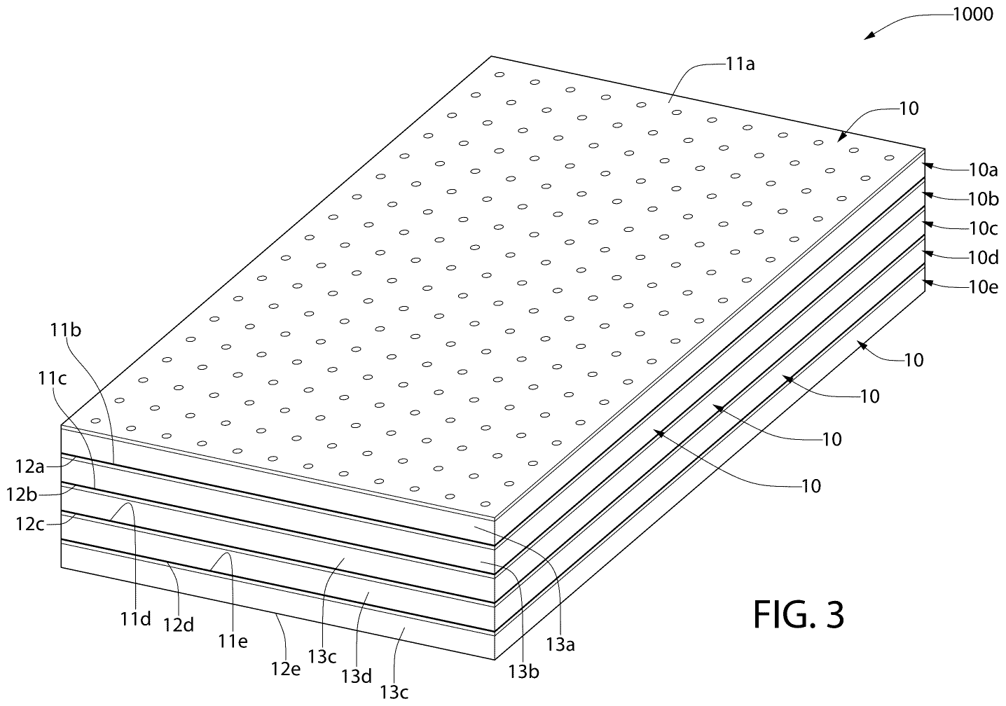

Referring now to FIG. 3, the present invention may further include a kit 1000 comprising a plurality of the protected building panels 10 arranged in a stacked configuration. The plurality of the protected building panels 10 may comprise at least a first one 10a of the protected building panel 10 and at least a second one 10b of the protected building panel 10. Although FIG. 3 only shows a total of five ones 10a, 10b, 10c, 10d, 10e of the protected building panel 10—the kit 1000 is not limited to only five ones of the protected building 10.

In the stacked configuration, the second exposed major surface 12a of the first one 10a of the protected building panel 10 may face the first exposed major surface 11b of the second one 10b of the protected building 10. In some embodiments of the stacked configuration, the second exposed major surface 12a of the first one 10a of the protected building panel 10 may be adjacent to the first exposed major surface 11b of the second one 10b of the protected building 10. In some embodiments of the stacked configuration, the second exposed major surface 12a of the first one 10a of the protected building panel 10 may contact the first exposed major surface 11b of the second one 10b of the protected building 10. In some embodiments, a spacer may be positioned between the second exposed major surface 12a of the first one 10a of the protected building panel 10 and the first exposed major surface 11b of the second one 10b of the protected building 10.

For stacked configurations comprise three 10a, 10b, 10c, or more of the protected building panel 10, in the stacked configuration, the second exposed major surface 12b of the second one 10b of the protected building panel 10 may face the first exposed major surface 11c of the third one 10c of the protected building 10. The second exposed major surface 12b of the second one 10b of the protected building panel 10 may be adjacent to the first exposed major surface 11c of the third one 10c of the protected building 10. In some embodiments of the stacked configuration, the second exposed major surface 12b of the second one 10b of the protected building panel 10 may contact the first exposed major surface 11c of the third one 10c of the protected building 10. In some embodiments, a spacer may be positioned between the second exposed major surface 12b of the second one 10b of the protected building panel 10 and the first exposed major surface 11c of the third one 10c of the protected building 10.

In the stacked configuration, the peelable film assembly 50 may impart a protective barrier between the upper surface 101 of the body 100 of the second one 10b of the protected building panel 10 from the above positioned first one 10a of the protected building panel 10. In such configuration, the kit 1000 may comprise a plurality of the protected building panel 10 in attacked configuration that is suitable for transport without damage to the upper surface 100 of the body 100 (or the lower surface 102 of the adjacent body 100), thereby helping improving appearance once the body 100 is installed in a room environment (as discussed further herein).

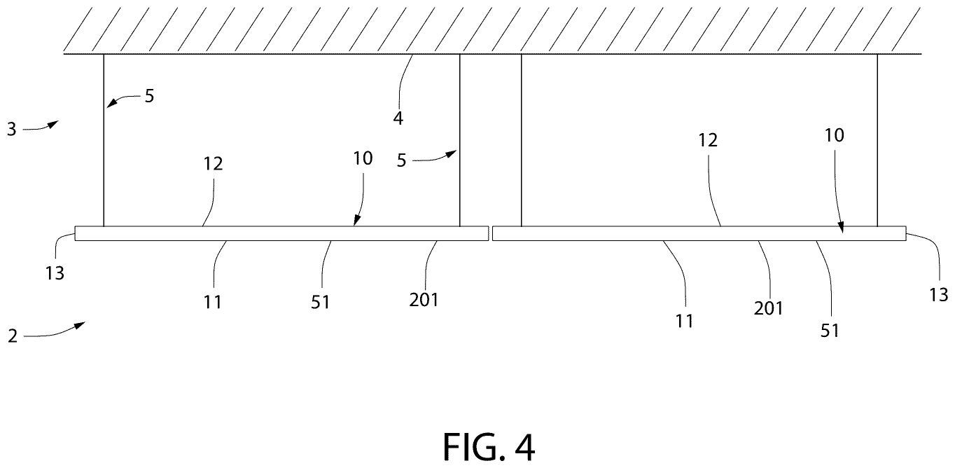

Referring to FIG. 4, the present invention includes a building system 1 comprising at least one protected building panel 10. The ceiling system 1 may comprise at least one or more of the protected building panels 10 installed in an interior space, whereby the interior space comprises a plenum space 3 and an active room environment 2. The plenum space 3 is defined by the space occupied between a structural barrier 4 between floors of a building and the second exposed major surface 12 of the building panel 10. The plenum space 3 provides space for mechanical lines within a building (e.g., HVAC, electrical lines, plumbing, telecommunications, etc.). The active space 2 is defined by the space occupied beneath the first exposed major surface 11 of the protected building panel 10 for one floor in the building. The active space 2 provides room for the building occupants during normal intended use of the building (e.g., in an office building, the active space would be occupied by offices containing computers, lamps, etc.).

Each of the building panels 10 may be supported in the interior space by one or more supports 5. Each of the building panels 10 are installed such that the first major exposed surface 11 of the building panel 10 faces the active room environment 2 and the lower major surface 12 of the building panel 10 faces the plenum space 3.

Once the protected building panel 10 is attached to the supports, the peelable film assembly 50 may be peeled from the body 100, thereby exposing the upper surface 101 of the body 100 to the room environment 2.

Each of the plurality of perforations 120 located within the body 120 may provide for airflow through the body 120 between the upper surface 121 and the lower surface 122. The resulting airflow may results in the body 120 suitable as an acoustic building panel capable of exhibiting acoustical performance-thereby allowing the building panel to function as an acoustical building panel. Specifically, the airflow may allow the building panel to exhibit noise reducing characteristics quantified by a Noise Reduction Coefficient (NRC) rating, as described in American Society for Testing and Materials (ASTM) test method C423. This rating is the average of sound absorption coefficients at four ⅓ octave bands (250, 500, 1000, and 2000 Hz), where, for example, a system having an NRC of 0.90 has about 90% of the absorbing ability of an ideal absorber. A higher NRC value indicates that the material provides better sound absorption and reduced sound reflection.

The body 100 as an ascetic building panel may exhibit an NRC of at least about 0.2 as measured between the first major exposed surface 101 and the second major exposed surface 102.

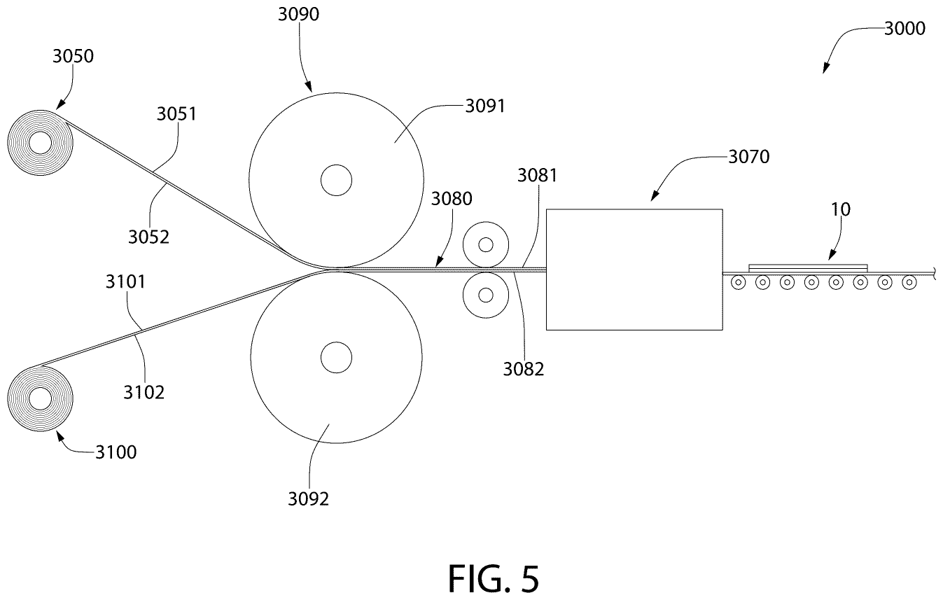

Referring now to FIG. 5, the present invention may include a system 3000 and related method of forming the protected building panel 10 of the present invention.

The system 3000 may comprise a first supply 3100 of substrate material (i.e., body material). The supply 3100 of substrate material may be in the form of a continuous sheet of the substrate material (i.e., metal roll). The first supply 3100 of substrate material may comprise an upper surface 3101 that shares the same surface ultimately with the upper surface 101 of the body 100 of the protected building panel 10. The first supply 3100 of substrate material may comprise a lower surface 2102 that shares the same surface ultimately with the lower surface 102 of the body 100 of the protected building panel 10.

The system 3000 may comprise a second supply 3050 of peelable film assembly material. The supply 3050 of peelable film assembly material may be in the form of a continuous sheet of the peelable film assembly (i.e., a roll). The second supply 3050 of peelable film assembly material may comprise an upper surface 3051 that shares the same surface ultimately with the upper surface 51 of the peelable film assembly 50 of the protected building panel 10. The second supply 3050 of peelable film assembly material may comprise a lower surface 3052 that shares the same surface ultimately with the lower surface 52 of the peelable film assembly 50 of the protected building panel 10.

The system 3000 and related method may comprise a step of joining together the continuous sheet 3100 of the substrate material and the continuous sheet 3050 of the peelable film assembly at joining stage 3090 to form a continuous laminate 3080. The joining stage 3090 may comprise a set of rollers 3091, 3092 to apply pressure to the substrate material and peelable film assembly material, thereby forming an adhesive bond therebetween by the pressure sensitive adhesive of the adhesive layer. The adhesive layer present in the lower surface 3052 of the second supply 3050 of the peelable film assembly material may contact the upper surface 3101 of first supply 3100 of the substrate material to form an adhesive bond there-between.

Subsequently, the system 3000 and related method may comprise a machining stage 3070, whereby at least one protected building panel 10 is cut from the continuous laminate 3080. The machining stage 3070 may comprise one or more cutting tools—e.g., die cutting tools, drilling tools, and/or punching tools.

During the machining stage 3070, the protected building panel 10 that is cut from the continuous laminate 3080 will exhibit the panel width W_{P} and panel length L_{P}. The machining stage 3070 further comprises forming a plurality of the perforations 20 into the protected building panel 10. Specifically, the machining stage 3070 may comprise punching the plurality of perforations 20 into the continuous laminate 3080 and through both the continuous sheet 3050 of the peelable film assembly and the continuous sheet 3100 of the of substrate material to form the plurality of panel perforations 20 of the protected building panel 10. The perforations 20 may be cut into the continuous laminate 3080 before, after, or contemporaneously as the perimeter of the protected building panel 10 is cut from the continuous laminate 3080.

Subsequently, after the machining stage 3070, the protected building panel 10 may be added to a kit 1000 and transported to a commercial center or job site and/or individually transported to a commercial center or job site.

The continuous sheet 3100 of substrate material and the continuous sheet 3050 of peelable film assembly prior to the machining stage 3070 may be substantially free of perforations.

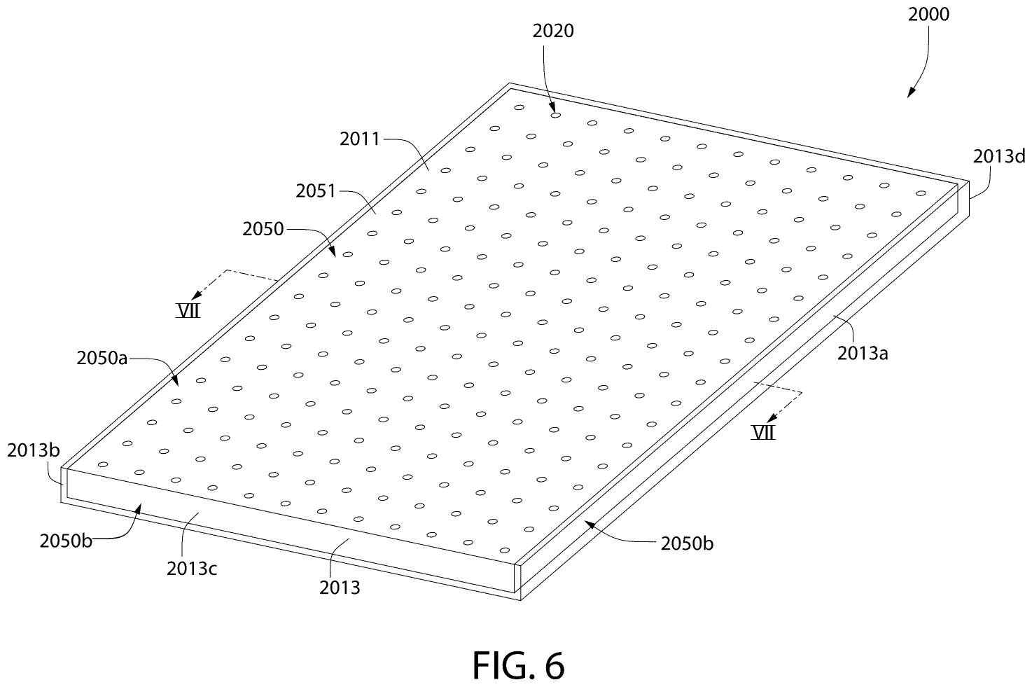

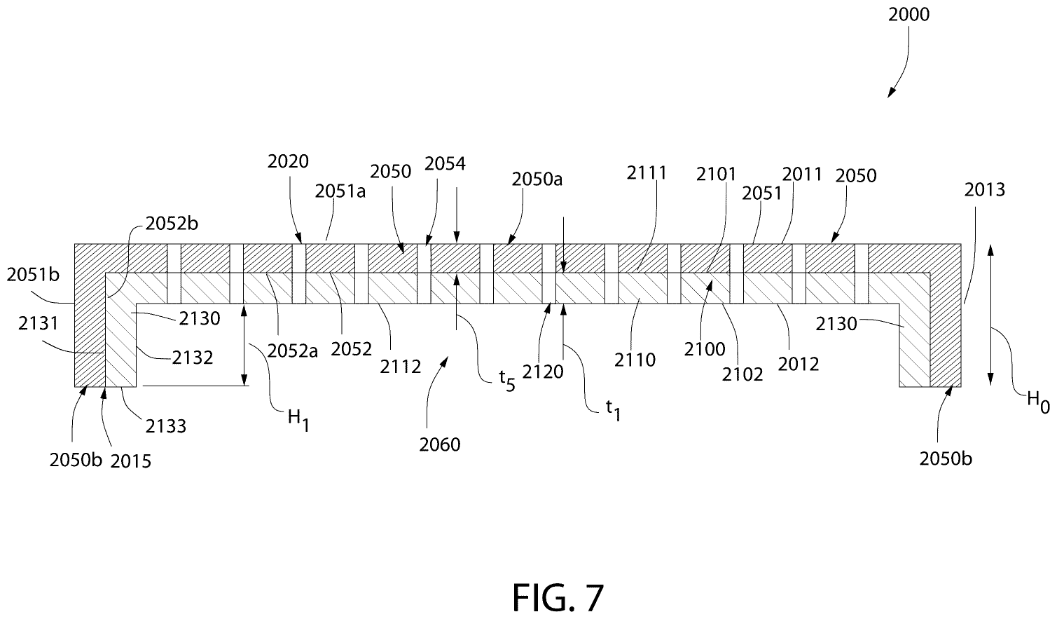

Referring now to FIGS. 6-8, a protected building panel 2000 according to another embodiment will be described herein. The previous discussion of the protected building panel 10 applies to the following discussion of the protected building panel 2010 except that a 2000-series number will be used to described and differences.

The body 2100 of the protected building panel 2010 may comprise a central body portion 2110 and a perimeter wall portion 2130. The central body portion 2110 may comprise a plurality of body perforations 2120. The perimeter wall portion 2130 may be substantially free of perforations.

The body 2100 may comprise an open cavity 2600 located in the open-volume created between the central body portion 2110 and the circumscribing perimeter wall portion 2130. A second body (not shown) may be inserted into the open cavity 2600. The second body may be a porous body. The second body may be a fibrous body. The second body may comprise inorganic fiber (e.g., mineral fiber). The second body may exhibit an NRC value of at least 0.5.

The central body portion 2110 may comprise an upper surface 2111 opposite a lower surface 2112. The upper surface 2111 of the central body portion 2110 may overlap with the upper surface 2101 of the body 2100. The lower surface 2112 of the central body portion 2110 may overlap with the lower surface 2102 of the body 2100. The central body portion 2110 may have a thickness equal to the body thickness t₁ of the body 2100 as measured between the upper surface 2111 and the lower surface 2112 of the central body portion 2110.

The perimeter wall portion 2130 may extend downward from the lower surface 2112 of the central body portion 2110 to a wall edge 2133 of the perimeter wall portion 2130. The perimeter wall portion 2130 may be oriented substantially orthogonal to the central body portion 2110.

The perimeter wall portion 2130 may have a wall height H₁ as measured from the lower surface 2112 of the central body portion 2110 to the wall edge 2133. The wall height H₁ may range from about 0.25 inch to about 6.0 inches—including all heights and sub-ranges there-between. In some embodiments, the wall height H₁ may range from about 0.5 inch to about 4.0 inches—including all heights and sub-ranges there-between. In some embodiments, the wall height H₁ may range from about 1.0 inch to about 3.0 inches—including all heights and sub-ranges there-between. In some embodiments, the wall height H₁ may range from about 1.0 inch to about 2.0 inches—including all heights and sub-ranges there-between.

The perimeter wall portion 2130 may comprise an inner surface 2132 opposite an outer surface 2131. The inner surface 2132 of the perimeter wall portion 2130 may face the open cavity 2060. The lower surface 2112 of the central body portion 2110 may face the open cavity 2060. The perimeter wall portion 2130 may have a thickness equal to the body thickness t₁ of the body 2100 as measured between the inner surface 2132 and the outer surface 2131 of the perimeter wall portion 2130. The thickness of the central body portion 2110 and the thickness of the perimeter wall portion 2130 may be substantially equal.

The central body portion 2110 may extend continuously into the perimeter wall portion 2130 of the body 2100.

The peelable film assembly 2050 may comprise a central portion 2050a and a perimeter portion 2050b. The central portion 2050a of the peelable film assembly 2050 a plurality of assembly perforations 2054. The perimeter portion 2050b may be substantially free of perforations.

The central portion 2050a of the peelable film assembly 2050 may be positioned adjacent to the central body portion 2110 of the body 2100. The perimeter portion 2050b of the peelable film assembly 2050 may be positioned adjacent to the perimeter wall portion 2130 of the body 2100.

The central portion 2050a of the peelable film assembly 2050 may comprise an upper surface 2051a opposite a lower surface 2052a. The upper surface 2051a of the central portion 2050a of the peelable film assembly 2050 may overlap with the upper surface 2051 of the peelable film assembly 2050. The lower surface 2052a of the central portion 2050a of the peelable film assembly 2050 may overlap with the lower surface 2052 of the peelable film assembly 2050. The central portion 2050a of the peelable film assembly 2050 may have a thickness equal to the peelable film assembly thickness t₅ as measured between the upper surface 2051a and the lower surface 2052a of the central portion 2050a of the peelable film assembly 2050.

The perimeter portion 2050b may extend downward from the lower surface 2052a of the central portion 2050a to the wall edge 2133 of the perimeter wall portion 2130.

The perimeter portion 2050b of the peelable film assembly 2050 may comprise an inner surface 2052b opposite an outer surface 2051b. The inner surface 2052b of the perimeter portion 2050b of the peelable film assembly 2050 may face the outer surface 2131 of the perimeter wall portion 2130 of the body 2100. The inner surface 2052b of the perimeter portion 2050b and the outer surface 2131 of the perimeter wall portion 2130 of the body 2100 may form at least part of the first interface 2015. The lower surface 2052a of the central portion 2050a of the peelable film assembly 2050 may face the upper surface 2111 of the central portion 2110 of the body 2100. The lower surface 2052a of the central portion 2050a of the peelable film assembly 2050 and the upper surface 2111 of the central portion 2110 of the body 2100 may form at least part of the first interface 2015.

The perimeter portion 2050b of the peelable film assembly 2050 may have a thickness equal to the film assembly thickness t₅. The central portion 2050a of the peelable film assembly 2050 may have a thickness equal to the film assembly thickness t₅. The thickness of the central portion 2050a of the peelable film assembly 2050 and the thickness of the perimeter portion 2050b of the peelable film assembly 2050 may be substantially equal.

The upper surface 2051a of the central portion 2050a may overlap with the upper surface 2051 of the peelable film assembly 2050. The lower surface 2052a of the central portion 2051a may overlap with the lower surface 2052 of the peelable film assembly 2050. The outer surface 2051b of the perimeter portion 2050b of the peelable film assembly 2050 may form at least part of the exposed side surface 2013 of the protected building panel 10.

A protected building panel height H₀ may extend from upper surface 2051a of the central portion 2050a of the peelable film assembly 2050 to the edge 2133 of the wall edge 2133 of the perimeter wall portion 2130. The protected building panel height H₀ may range from about 0.25 inch to about 6.0 inches—including all heights and sub-ranges there-between. In some embodiments, the wall height H₁ may range from about 0.5 inch to about 4.0 inches—including all heights and sub-ranges there-between. In some embodiments, the wall height H₁ may range from about 1.0 inch to about 3.0 inches—including all heights and sub-ranges there-between. In some embodiments, the wall height H₁ may range from about 1.0 inch to about 2.0 inches-including all heights and sub-ranges there-between.

### EXEMPLARY CLAIMS

The disclosure may be characterized by the following Exemplary Claims:

Exemplary Claim 1. A protected building panel having a first major exposed surface opposite a second major exposed surface, the protected building panel comprising: a substrate comprising a first major surface opposite a second major surface; a peelable film assembly comprising: a film layer comprising a first major surface opposite a second major surface, the peelable film having a film thickness as measured by the distance between the first major surface and the second major surface of the peelable film, and the peelable film formed of a film composition comprising coextruded blend a first polyolefin comprising low-density polyethylene and a second polyolefin that is different from the first polyolefin; an adhesive layer comprising a first major surface opposite a second major surface, the adhesive layer having an adhesive thickness as measured by the distance between the first major surface and the second major surface of the adhesive layer; wherein the second major surface of the film layer is adjacent to the first major surface of the substrate by the adhesive layer; wherein a ratio of the film thickness to the adhesive thickness ranges from about 3:1 to about 5:1; wherein the protected building panel comprising a plurality of perforations extending continuously through the peelable film assembly and the substrate.

Exemplary Claim 2. The protected building panel according to Exemplary Claim 1, wherein the ratio of the film thickness to the adhesive thickness ranges from about 3.5:1 to about 4:1.

Exemplary Claim 3. The protected building panel according to any one of Exemplary Claims 1 to 2, wherein the ratio of the film thickness to the adhesive thickness is about 3.7:1.

Exemplary Claim 4. The protected building panel according to any one of Exemplary Claims 1 to 3, wherein the film composition comprises the blend of the first polyolefin and the second polyolefin in an amount ranging from about 75 wt. % to about 95 wt. % based on the total weight of the film composition.

Exemplary Claim 5. The protected building panel according to any one of Exemplary Claims 1 to 3, wherein the film composition further comprises an slip agent in an amount ranging from a non-zero wt. % up to about 5 wt. %.

Exemplary Claim 6. The protected building panel according to any one of Exemplary Claims 1 to 4, wherein the film composition further comprises an anti-blocking agent in an amount ranging from a non-zero wt. % up to about 5 wt. %.

Exemplary Claim 7. The protected building panel according to any one of Exemplary Claims 1 to 6, wherein the film thickness ranges from about 1.0 mils to about 1.5 mils.

Exemplary Claim 8. The protected building panel according to Exemplary Claim 7, wherein the film thickness is about 1.3 mils.

Exemplary Claim 9. The protected building panel according to any one of Exemplary Claims 1 to 8, wherein the adhesive thickness ranges from about 0.2 mils to about 0.5 mils.

Exemplary Claim 10. The protected building panel according to Exemplary Claim 9, wherein the adhesive thickness is about 0.35 mils.

Exemplary Claim 11. The protected building panel according to any one of Exemplary Claims 1 to 10, wherein the film layer and the adhesive layer is optically clear.

Exemplary Claim 12. The protected building panel according to any one of Exemplary Claims 1 to 11, the peelable film assembly further comprising a print layer positioned between the film layer and the adhesive layer.

Exemplary Claim 13. The protected building panel according to any one of Exemplary Claims 1 to 12, wherein the adhesive layer comprises an adhesive composition comprising a blend of poly(butyl acrylate) and poly(methyl methacrylate).

Exemplary Claim 14. The protected building panel according to Exemplary Claim 13, wherein the poly(butyl acrylate) is present in an amount ranging from about 40 wt. % to about 90 wt. % based on the total weight of the adhesive composition and the poly(methyl methacrylate) is present in an amount ranging from about 10 wt. % to about 30 wt. % based on the total weight of the adhesive composition.

Exemplary Claim 15. The protected building panel according to any one of Exemplary Claims 13 to 14, wherein the adhesive composition further comprises a crosslinker.

Exemplary Claim 16. The protected building panel according to Exemplary Claim 15, wherein the crosslinker is selected from one or more of aluminum acetylacetonate, N-(hydroxymethyl) acrylamide, 1,1′-carbonyldiimidazole, and combinations thereof.

Exemplary Claim 17. The protected building panel according to any one of Exemplary Claims 15 to 16, wherein the crosslinker is present in an amount ranging from about 0.5 wt. % to about 5 wt. % based on the total weight of the adhesive composition.

Exemplary Claim 18. The protected building panel according to any one of Exemplary Claims 13 to 17, wherein the adhesive composition is substantially free of tackifier.

Exemplary Claim 19. The protected building panel according to any one of Exemplary Claims 1 to 18, wherein the substrate is formed of a metal.

Exemplary Claim 20. The protected building panel according to any one of Exemplary Claims 1 to 19, wherein the first major surface of the substrate exhibits a surface energy ranging from about 32 dyne to about 34 dyne.

Exemplary Claim 21. A protected building panel having a first major exposed surface opposite a second major exposed surface, the protected building panel comprising: a substrate comprising a first major surface opposite a second major surface; a peelable film assembly comprising:
a film layer comprising a first major surface opposite a second major surface, the peelable film having a film thickness as measured by the distance between the first major surface and the second major surface of the peelable film, and the peelable film formed of a film composition comprising a coextruded blend a first polyolefin comprising low-density polyethylene and a second polyolefin that is different from the first polyolefin, the film thickness ranging from about 1.0 mils to about 1.5 mils; an adhesive layer comprising a first major surface opposite a second major surface, the adhesive layer having an adhesive thickness as measured by the distance between the first major surface and the second major surface of the adhesive layer, the adhesive layer formed of an adhesive composition comprising poly(butyl acrylate), poly(methyl methacrylate), acrylic copolymer, and a crosslinker, the adhesive thickness ranging from about 0.2 mils to about 0.5 mils; wherein the second major surface of the film layer is adjacent to the first major surface of the substrate by the adhesive layer; and wherein the film layer and the adhesive layer are optically clear.

Exemplary Claim 22. The protected building panel according to Exemplary Claim 21, wherein the film thickness is about 1.3 mils.

Exemplary Claim 23. The protected building panel according to any one of Exemplary Claims 21 to 22, wherein the adhesive thickness is about 0.35 mils.

Exemplary Claim 24. The protected building panel according to any one of Exemplary Claims 21 to 23, wherein the film composition comprises the blend of the first polyolefin and the second polyolefin in an amount ranging from about 75 wt. % to about 95 wt. % based on the total weight of the film composition.

Exemplary Claim 25. The protected building panel according to any one of Exemplary Claims 21 to 23, wherein the film composition further comprises an slip agent in an amount ranging from a non-zero wt. % up to about 5 wt. %.

Exemplary Claim 26. The protected building panel according to any one of Exemplary Claims 21 to 24, wherein the film composition further comprises an anti-blocking agent in an amount ranging from a non-zero wt. % up to about 5 wt. %.

Exemplary Claim 27. The protected building panel according to any one of Exemplary Claims 21 to 26, wherein the adhesive layer comprises an adhesive composition comprising a blend of poly(butyl acrylate) and poly(methyl methacrylate).

Exemplary Claim 28. The protected building panel according to any one of Exemplary Claims 21 to 27, wherein the poly(butyl acrylate) is present in an amount ranging from about 40 wt. % to about 90 wt. % based on the total weight of the adhesive composition and the poly(methyl methacrylate) is present in an amount ranging from about 10 wt. % to about 30 wt. % based on the total weight of the adhesive composition.

Exemplary Claim 29. The protected building panel according to any one of Exemplary Claims 21 to 28, wherein the adhesive composition further comprises a crosslinker.

Exemplary Claim 30. The protected building panel according to Exemplary Claim 29, wherein the crosslinker is selected from one or more of aluminum acetylacetonate, N-(hydroxymethyl) acrylamide, 1,1′-carbonyldiimidazole, and combinations thereof.

Exemplary Claim 31. The protected building panel according to any one of Exemplary Claims 21 to 30, wherein the crosslinker is present in an amount ranging from about 0.5 wt. % to about 5 wt. % based on the total weight of the adhesive composition.

Exemplary Claim 32. The protected building panel according to any one of Exemplary Claims 21 to 31, wherein the adhesive composition is substantially free of tackifier.

Exemplary Claim 33. The protected building panel according to any one of Exemplary Claims 21 to 32, the peelable film assembly further comprising a print layer positioned between the film layer and the adhesive layer.

Exemplary Claim 32. The protected building panel according to any one of Exemplary Claims 21 to 33, wherein the substrate is formed of a metal.

Exemplary Claim 33. The protected building panel according to any one of Exemplary Claims 21 to 32, wherein the first major surface of the substrate exhibits a surface energy ranging from about 32 dyne to about 34 dyne.

Exemplary Claim 34. A protected building panel having a first exposed major surface opposite a second exposed major surface, the protected building panel comprising: a substrate comprising: a central portion comprising an upper surface opposite a lower surface; a perimeter wall portion extending downward from the lower surface of the central portion, the perimeter wall comprising an inner surface opposite an outer surface; a peelable film assembly comprising: a central portion adjacent to the upper surface of the central portion of the substrate and a perimeter portion adjacent to outer surface of the perimeter wall portion of the substrate; the peelable film assembly comprising a film layer having a film thickness, the film layer formed of a film composition comprising coextruded blend a first polyolefin comprising low-density polyethylene and a second polyolefin that is different from the first polyolefin; and an adhesive layer having an adhesive thickness; wherein a ratio of the film thickness to the adhesive thickness ranges from about 3:1 to about 5:1; wherein the protected building panel comprising a plurality of perforations extending continuously through the central portion of the substrate and the central portion of the peelable film assembly and the substrate.

Exemplary Claim 35. The protected building panel according to Exemplary Claim 34, wherein the ratio of the film thickness to the adhesive thickness ranges from about 3.5:1 to about 4:1.

Exemplary Claim 36. The protected building panel according to any one of Exemplary Claims 34 to 35, wherein the ratio of the film thickness to the adhesive thickness is about 3.7:1.

Exemplary Claim 37. The protected building panel according to any one of Exemplary Claims 34 to 36, wherein the film composition comprises the blend of the first polyolefin and the second polyolefin in an amount ranging from about 75 wt. % to about 95 wt. % based on the total weight of the film composition.

Exemplary Claim 38. The protected building panel according to any one of Exemplary Claims 34 to 37, wherein the substrate comprises an open cavity located adjacent to the lower surface of the central portion of the substrate and adjacent to the inner surface of the perimeter wall portion of the substrate.

Exemplary Claim 39. The protected building panel according to any one of Exemplary Claims 34 to 38, wherein the perimeter wall portion extends downward from the lower surface of the central portion to a wall edge, wherein the peelable film assembly comprises an upper surface opposite a lower surface, the lower surface of the peelable film assembly adjacent to the substrate; and wherein the protected building panel having a panel height as measured from the upper surface of the peelable film assembly to the wall edge of the perimeter wall portion, the panel height ranging from about 0.25 inches to about 6.0 inches.

Exemplary Claim 40. The protected building panel according to Exemplary Claim 39, wherein the panel height ranging from about 1.0 inch to about 4.0 inches.

Exemplary Claim 41. The protected building panel according to any one of Exemplary Claims 34 to 40, wherein the film thickness ranges from about 1.0 mils to about 1.5 mils.

Exemplary Claim 42. The protected building panel according to Exemplary Claim 41, wherein the film thickness is about 1.3 mils.

Exemplary Claim 43. The protected building panel according to any one of Exemplary Claims 34 to 42, wherein the adhesive thickness ranges from about 0.2 mils to about 0.5 mils.

Exemplary Claim 44. The protected building panel according to Exemplary Claim 43, wherein the adhesive thickness is about 0.35 mils.

Exemplary Claim 45. The protected building panel according to any one of Exemplary Claims 34 to 44, wherein the adhesive layer comprises an adhesive composition comprising a blend of poly(butyl acrylate) and poly(methyl methacrylate).

Exemplary Claim 46. The protected building panel according to Exemplary Claim 45, wherein the adhesive composition is substantially free of tackifier.

Exemplary Claim 47. The protected building panel according to any one of Exemplary Claims 34 to 46, wherein the substrate is formed of a metal.

Exemplary Claim 48. The protected building panel according to any one of Exemplary Claims 34 to 47, wherein the perimeter wall portion of the substrate is free of perforations.

Exemplary Claim 49. A building panel kit comprising: a plurality of the protected building panels according to any one of Exemplary Claims 1 to 48, the plurality of the protected building panels comprising at least: a first one of the protected building panels and a second one of the protected building panels arranged in a stacked configuration; wherein the second exposed major surface of the first one of the protected building panels is adjacent to the first exposed major surface of the second one of the protected buildings.

Exemplary Claim 50. The building panel kit according to Exemplary Claim 49, wherein the plurality of the protected building panels further comprises a third one of the protected building panels in the stacked configuration; wherein the second exposed major surface of the second one of the protected building panels is adjacent to the first exposed major surface of the third one of the protected buildings.

Exemplary Claim 51. The building panel kit according to any one of Exemplary Claims 49 to 50, wherein the second exposed major surface of the first one of the protected building panels contacts the first exposed major surface of the second one of the protected buildings.

Exemplary Claim 52. The building panel kit according to any one of Exemplary Claims 49 to 51, wherein the second exposed major surface of the second one of the protected building panels contacts the first exposed major surface of the third one of the protected buildings.

Exemplary Claim 53. A method of forming a protected building panel comprising: a) providing a continuous sheet of substrate material and providing a continuous sheet of peelable film assembly; b) joining together the continuous sheet of the substrate material and the continuous sheet of the peelable film assembly to form a continuous laminate having an upper surface comprising the peelable film assembly opposite a lower surface comprising the substrate material; c) performing a machining step whereby at least one protected building panel is cut from the continuous laminate, wherein the protected building panel that is cut from the continuous laminate has a panel width and panel length as well as a first major exposed surface opposite a second major exposed surface; and wherein the protected building panel that is cut from the continuous laminate further comprises plurality of perforations that extend continuously from the first major exposed surface to the second major exposed surface of the protected building panel.

Exemplary Claim 54. The method according to Exemplary Claim 53, wherein step c) comprising a perforation punching step that forms the plurality of perforations in the protected building panel.

Exemplary Claim 55. The method according to Exemplary Claim 54, wherein the punching step comprises punching perforations through both of the continuous sheet of substrate material and the continuous sheet of peelable film during step c).

Exemplary Claim 56. The method according to any one of Exemplary Claims 53 to 55, wherein each of the continuous sheet of substrate material and the continuous sheet of peelable film assembly in step a) are substantially free of perforations.

The following examples are prepared in accordance with the present invention. The present invention is not limited to the examples described herein.

### EXAMPLES

A series of experiments were performed to test the adhesion and peel performance properties of peelable film assembly of the present invention. The composition details of each film layer and adhesive layer are listed below
Film Type 1 (“1”)—polymeric film comprising a coextruded blend of polyolefin that includes a first polyethylene of LDPE and a second polyethylene, the second polyethylene different from the first polyethylene;
Film Type 2 (“2”)—polymeric film comprising first polyolefin of LDPE Film Type 3 (“3”)—polymeric film comprising first polyolefin of polyethylene
Adhesive Type 1 (“1”)—acrylic adhesive comprising poly(butyl acrylate), poly(methyl methacrylate), acrylic copolymer, and a crosslinker (no tackifier);
Adhesive Type 2 (“2”)—acrylic adhesive comprising poly(butyl acrylate), poly(methyl methacrylate), and acrylic copolymer, rosin ester as a tackifier (20-30%), and a crosslinker;
Adhesive Type 3 (“3”)—acrylic adhesive comprising poly(butyl acrylate), poly(methyl methacrylate), acrylic copolymer, rosin ester as a tackifier (10-20%), and a crosslinker;
Adhesive Type 4 (“3”)—acrylic adhesive comprising poly(butyl acrylate), poly(methyl methacrylate), rosin ester as a tackifier (10-20%), and a crosslinker;
Each of the films were tested for elongation along the machine direction (“MD”) as well as against the machine direction “AMD”—which is defined as a direction at least 10° oblique to the MD. Each of the films were also tested amount of film stretch during peel in the MD.

“NM” refers to values not measured

TABLE 1

| | | Comp. | Comp. | Comp. | Comp. | Comp. | Comp. | Comp. |
|---|---|---|---|---|---|---|---|---|
| | Ex. 1 | Ex. 1 | Ex. 2 | Ex. 3 | Ex. 4 | Ex. 5 | Ex. 6 | Ex. 7 |
| Film Type | 1 | 2 | 2 | 2 | 3 | 3 | 3 | 3 |
| Film | 1.3 | 1.2 | 1.5 | 2.5 | 1.5 | 1.2 | 1.2 | 1.2 |
| Thickness (FT) | mils | mils | mils | mils | mils | mils | mils | Mils |
| Adhesive Type | 1 | 2 | 2 | 2 | 3 | 4 | 4 | 4 |
| Adhesive | 0.35 | 0.3 | 0.2 | 0.2 | 0.3 | 0.35 | 0.25 | 0.3 |
| Thickness (AT) | mils | mils | mils | mils | mils | mils | mils | mils |
| Ratio FT:AT | 3.7:1 | 4.0:1 | 7.5:1 | 12.5:1 | 5:1 | 3.4:1 | 4.8:1 | 4:1 |
| Total | 1.65 | 1.5 | 1.7 | 2.7 | 1.8 | 1.5 | 1.5 | 1.5 |
| Thickness | mils | mils | mils | mils | mils | mils | mils | mils |
| Elongation MD | 385% | 226% | 251% | 457% | 403% | 407% | NM | 363% |
| Elongation AMD | 484% | 587% | 732% | 484% | 537% | 615% | NM | 693% |
| Stretch | −0.1% | −0.2% | 0.1% | −0.9% | −0.1% | 0.7% | −0.6% | −0.4% |
| During Peel | to 1.3% | to 1.4% | to 2.5% | to 0.4% | to 6.2% | to 2.5% | to 0.1% | to 1.0% |

The film and adhesive of Ex. 1 was the only peelable film assembly to exhibit elongation along the machine direction of less than 400% and against the machine direction of less than 500%—thereby providing a superior film assembly.

Subsequently, the film assemblies were applied to a number of substrates and tested for peel perforation. Below are the substrates tested.
Substrate 1 (“1”)—metal substrate having a first major surface opposite a second major surface, the first major surface being textured and having a surface energy of 32 dyne;
Substrate 2 (“2”)—metal substrate having a first major surface opposite a second major surface, the first major surface being smooth and having a surface energy of 32-34 dyne;

TABLE 2

| | | | Initial | 4-Month | 7-Month | | |
|---|---|---|---|---|---|---|---|
| | | | Adhesion | Adhesion | Adhesion | | |
| | Protective | Substrate | Force | Force | Force | Film | Adhesion |
| | Film | Type | (lbf/in) | (lbf/in) | (lbf/in) | Integrity | Peel |
| Panel 1 | Ex. 1 | 1 | 0.17 | 0.27 | 0.31 | Pass | Pass |
| Panel 2 | Ex. 1 | 2 | 0.21 | 0.37 | 0.43 | Pass | Pass |
| Panel 3 | Ex. 1 | 3 | 0.32 | 0.46 | 0.51 | Pass | Pass |
| Panel 4 | Comp. | 1 | 0.4 | NM | NM | Fail | Fail |
| | Ex. 1 | | | | | | |
| Panel 5 | Comp. | 2 | 0.57 | NM | NM | Fail | Fail |
| | Ex. 1 | | | | | | |
| Panel 6 | Comp. | 3 | 0.57 | NM | NM | Fail | Fail |
| | Ex. 1 | | | | | | |
| Panel 7 | Comp. | 1 | 0.46 | NM | NM | Fail | Fail |
| | Ex. 2 | | | | | | |
| Panel 8 | Comp. | 2 | 0.64 | NM | NM | Fail | Fail |
| | Ex. 2 | | | | | | |
| Panel 9 | Comp. | 3 | 0.63 | NM | NM | Fail | Fail |
| | Ex. 2 | | | | | | |
| Panel 10 | Comp. | 1 | 0.26 | NM | NM | Fail | Fail |
| | Ex. 3 | | | | | | |
| Panel 11 | Comp. | 2 | 0.62 | NM | NM | Fail | Fail |
| | Ex. 3 | | | | | | |
| Panel 12 | Comp. | 3 | 0.52 | NM | NM | Fail | Fail |
| | Ex. 3 | | | | | | |
| Panel 13 | Comp. | 1 | 0.72 | 0.86 | 0.9 | Fail | Fail |
| | Ex. 4 | | | | | | |
| Panel 14 | Comp. | 2 | 0.56 | 1.1 | 1.07 | Fail | Fail |
| | Ex. 4 | | | | | | |
| Panel 15 | Comp. | 3 | 1.05 | 0.85 | 0.89 | Fail | Fail |
| | Ex. 4 | | | | | | |
| Panel 16 | Comp. | 1 | 0.68 | NM | NM | Fail | Fail |
| | Ex. 5 | | | | | | |
| Panel 17 | Comp. | 2 | 0.79 | NM | NM | Fail | Fail |
| | Ex. 5 | | | | | | |
| Panel 18 | Comp. | 3 | 0.88 | NM | NM | Fail | Fail |
| | Ex. 5 | | | | | | |
| Panel 19 | Comp. | 1 | 0.15 | NM | NM | Pass | Fail |
| | Ex. 6 | | | | | | |
| Panel 20 | Comp. | 2 | 0.35 | NM | NM | Pass | Fail |
| | Ex. 6 | | | | | | |
| Panel 21 | Comp. | 3 | 0.31 | NM | NM | Pass | Fail |
| | Ex. 6 | | | | | | |
| Panel 22 | Comp. | 1 | NM | 0.41 | NM | Pass | Fail |
| | Ex. 7 | | | | | | |
| Panel 23 | Comp. | 2 | 0.45 | 0.66 | NM | Pass | Fail |
| | Ex. 7 | | | | | | |
| Panel 24 | Comp. | 3 | 0.36 | 0.4 | NM | Pass | Fail |
| | Ex. 7 | | | | | | |

Again, only the peelable film assembly of Ex. 1 exhibit both a passing grade in terms of film integrity during peel (i.e., did not rupture) and full removal of adhesive during peel (i.e., no adhesive remain on substrate after peel)-reflecting an unexpected synergy in peelable film assembly performance.

What is claimed is:

1. A protected building panel having a first major exposed surface opposite a second major exposed surface, the protected building panel comprising:
a substrate comprising a first major surface opposite a second major surface;
a peelable film assembly comprising:
a film layer comprising a first major surface opposite a second major surface, the peelable film having a film thickness as measured by the distance between the first major surface and the second major surface of the peelable film, and the peelable film formed of a film composition comprising coextruded blend a first polyolefin comprising low-density polyethylene and a second polyolefin that is different from the first polyolefin;
an adhesive layer comprising a first major surface opposite a second major surface, the adhesive layer having an adhesive thickness as measured by the distance between the first major surface and the second major surface of the adhesive layer;
wherein the second major surface of the film layer is adjacent to the first major surface of the substrate by the adhesive layer;
wherein a ratio of the film thickness to the adhesive thickness ranges from about 3:1 to about 5:1;
wherein the protected building panel comprising a plurality of perforations extending continuously through the peelable film assembly and the substrate.

2. The protected building panel according to claim 1, wherein the ratio of the film thickness to the adhesive thickness ranges from about 3.5:1 to about 4:1.

3. The protected building panel according to claim 1, wherein the film composition comprises the blend of the first polyolefin and the second polyolefin in an amount ranging from about 75 wt. % to about 95 wt. % based on the total weight of the film composition.

4. The protected building panel according to claim 1, wherein the film composition further comprises an slip agent in an amount ranging from a non-zero wt. % up to about 5 wt. %.

5. The protected building panel according to claim 1, wherein the film composition further comprises an anti-blocking agent in an amount ranging from a non-zero wt. % up to about 5 wt. %.

6. The protected building panel according to claim 1, wherein the adhesive layer comprises an adhesive composition comprising a blend of poly(butyl acrylate) and poly(methyl methacrylate).

7. The protected building panel according to claim 6, wherein the crosslinker is selected from one or more of aluminum acetylacetonate, N-(hydroxymethyl) acrylamide, 1,1′-carbonyldiimidazole, and combinations thereof.

8. A protected building panel having a first major exposed surface opposite a second major exposed surface, the protected building panel comprising:
a substrate comprising a first major surface opposite a second major surface;
a peelable film assembly comprising:
a film layer comprising a first major surface opposite a second major surface, the peelable film having a film thickness as measured by the distance between the first major surface and the second major surface of the peelable film, and the peelable film formed of a film composition comprising a coextruded blend a first polyolefin comprising low-density polyethylene and a second polyolefin that is different from the first polyolefin, the film thickness ranging from about 1.0 mils to about 1.5 mils;
an adhesive layer comprising a first major surface opposite a second major surface, the adhesive layer having an adhesive thickness as measured by the distance between the first major surface and the second major surface of the adhesive layer, the adhesive layer formed of an adhesive composition comprising poly(butyl acrylate), poly(methyl methacrylate), acrylic copolymer, and a crosslinker, the adhesive thickness ranging from about 0.2 mils to about 0.5 mils;
wherein the second major surface of the film layer is adjacent to the first major surface of the substrate by the adhesive layer; and
wherein the film layer and the adhesive layer are optically clear.

9. The protected building panel according to claim 8, wherein the film composition comprises the blend of the first polyolefin and the second polyolefin in an amount ranging from about 75 wt. % to about 95 wt. % based on the total weight of the film composition.

10. The protected building panel according to claim 8, wherein the film composition further comprises an slip agent in an amount ranging from a non-zero wt. % up to about 5 wt. %.

11. The protected building panel according to claim 8, wherein the film composition further comprises an anti-blocking agent in an amount ranging from a non-zero wt. % up to about 5 wt. %.

12. The protected building panel according to claim 8, wherein the adhesive layer comprises an adhesive composition comprising a blend of poly(butyl acrylate) and poly(methyl methacrylate).

13. The protected building panel according to claim 8, wherein the poly(butyl acrylate) is present in an amount ranging from about 40 wt. % to about 90 wt. % based on the total weight of the adhesive composition and the poly(methyl methacrylate) is present in an amount ranging from about 10 wt. % to about 30 wt. % based on the total weight of the adhesive composition.

14. The protected building panel according to claim 13, wherein the crosslinker is selected from one or more of aluminum acetylacetonate, N-(hydroxymethyl) acrylamide, 1,1′-carbonyldiimidazole, and combinations thereof.

15. A protected building panel having a first exposed major surface opposite a second exposed major surface, the protected building panel comprising:
a substrate comprising:
a central portion comprising an upper surface opposite a lower surface;
a perimeter wall portion extending downward from the lower surface of the central portion, the perimeter wall comprising an inner surface opposite an outer surface;
a peelable film assembly comprising:
a central portion adjacent to the upper surface of the central portion of the substrate and a perimeter portion adjacent to outer surface of the perimeter wall portion of the substrate;
the peelable film assembly comprising a film layer having a film thickness, the film layer formed of a film composition comprising coextruded blend a first polyolefin comprising low-density polyethylene and a second polyolefin that is different from the first polyolefin; and an adhesive layer having an adhesive thickness;
wherein a ratio of the film thickness to the adhesive thickness ranges from about 3:1 to about 5:1;
wherein the protected building panel comprising a plurality of perforations extending continuously through the central portion of the substrate and the central portion of the peelable film assembly and the substrate.

16. The protected building panel according to claim 15, wherein the ratio of the film thickness to the adhesive thickness ranges from about 3.5:1 to about 4:1.

17. The protected building panel according to claim 15, wherein the film composition comprises the blend of the first polyolefin and the second polyolefin in an amount ranging from about 75 wt. % to about 95 wt. % based on the total weight of the film composition.

18. The protected building panel according to claim 15, wherein the substrate comprises an open cavity located adjacent to the lower surface of the central portion of the substrate and adjacent to the inner surface of the perimeter wall portion of the substrate.

19. The protected building panel according to claim 15,
wherein the perimeter wall portion extends downward from the lower surface of the central portion to a wall edge,
wherein the peelable film assembly comprises an upper surface opposite a lower surface, the lower surface of the peelable film assembly adjacent to the substrate; and
wherein the protected building panel having a panel height as measured from the upper surface of the peelable film assembly to the wall edge of the perimeter wall portion, the panel height ranging from about 0.25 inches to about 6.0 inches.

20. The protected building panel according to claim 15, wherein the adhesive layer comprises an adhesive composition comprising a blend of poly(butyl acrylate) and poly(methyl methacrylate).
